(19) United States
(12) Patent Application Publication
(10) Pub. No.: US 2009/0216710 A1
(43) Pub. Date: Aug. 27, 2009

(54) OPTIMIZING QUERY REWRITES FOR KEYWORD-BASED ADVERTISING

(75) Inventors: Chi-Chao Chang, Santa Clara, CA (US); Shanmugasundaram Ravikumar, Berkeley, CA (US); Azarakhsh Malekian, College Park, CA (US); Grant Wang, Mountain View, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 12/038,259

(22) Filed: Feb. 27, 2008

(51) Int. Cl. G06F 17/30

(52) U.S. Cl. 707/2; 707/E17.017

(57) ABSTRACT

A system and method are disclosed for rewriting queries. The queries may be rewritten and evaluated based on an end benefit, such as an optimum advertising benefit. Queries may be associated with advertisements and the benefit of those advertisements may be used in selecting query rewrites for an original user query. Multiple query rewrites from various techniques may be analyzed to generate a subset of query rewrites that are optimized for a particular benefit.

### BACKGROUND

Online advertising may be an important source of revenue for enterprises engaged in electronic commerce. A number of different kinds of web page based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a web page to be configured to contain a location for inclusion of an advertisement. A page may not only be a web page, but any other electronically created page or document. An advertisement can be selected for display each time the page is requested, for example, by a browser or server application.

Online advertising may be linked to online searching. Online searching is a common way for consumers to locate information, goods, or services on the Internet. A consumer may use an online search engine to type in a query to search for other pages or web sites with information related to that query. When the advertising that is shown on the search engine page is related to the query, the search may be referred to as a sponsored search. Sponsored searching may require advertisers to bid for search keywords, which are associated with the search query for displaying advertisements with the search results. The search query may need to be rewritten for a variety of reasons, including potential misspellings or to match with a search keyword.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a block diagram of an exemplary network system;

FIG. 2 is a block diagram of a query rewrite analyzer;

FIG. 3 is block diagram illustrating optimization;

FIG. 4 is a flow diagram for selecting query rewrites;

FIG. 5 is bipartite graph illustrating queries and advertisements; and

FIG. 6 is a flow diagram of optimization constraints.

### DETAILED DESCRIPTION

By way of introduction, included below is a system and method for selecting query rewrites. The queries may be rewritten and evaluated based on an end benefit, such as optimum advertising revenue. Multiple query rewrites from various techniques may be analyzed to generate a subset of query rewrites that are optimized for a particular benefit. The queries may be used by advertisers for sponsored searching by being associated with advertisements that are displayed when that query is received. The associated queries may be used for selecting the advertisements that are displayed with the search results for that search query. A given query may be substituted with other queries based on an association with advertisements. For example, a given query may be substituted with another query when the other query is associated with a popular or profitable advertisement. Alternatively, a different benefit for a substitute query may be identified and the query rewriting or substitution may be based on that benefit.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

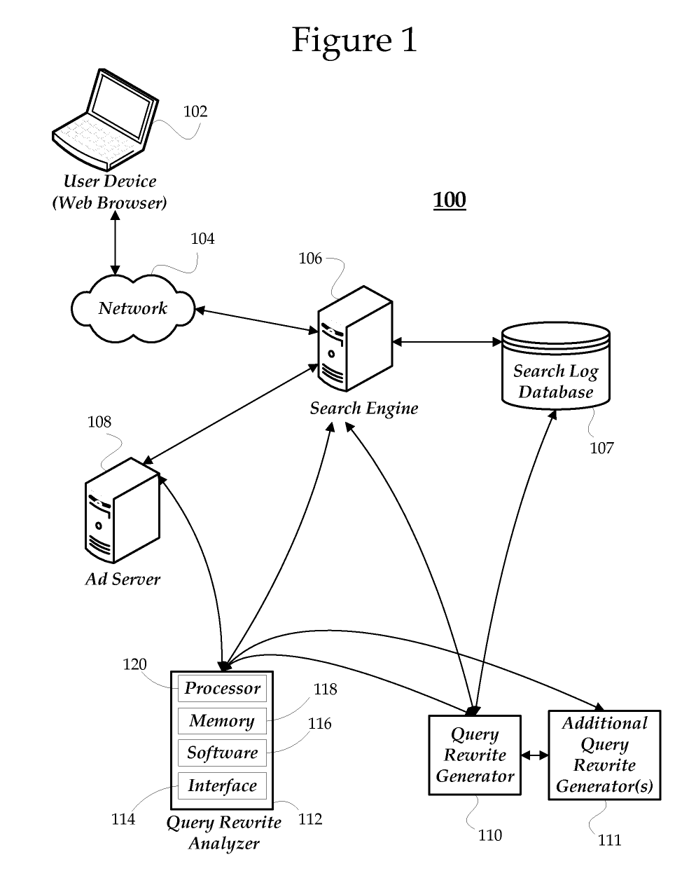

FIG. 1 provides a simplified view of a network system 100 in which the present system and methods may be implemented. Not all of the depicted components may be required, however, and some systems may include additional, different, or fewer components not shown in the figure may be provided. Variations in the arrangement and type of the components may be made without departing from the spirit or scope of the claims as set forth herein.

FIG. 1 is a block diagram illustrating an exemplary network system 100 for query rewrite generation and analysis. In particular, system 100 includes a query rewrite analyzer 112 that may receive potential query rewrites from a query rewrite generator 110 and/or additional query rewrite generator(s) 111 and analyze those rewrites to optimize the benefit of providing substitute queries. A user device 102 is coupled with a search engine 106 through the network 104. The search engine 106 is coupled with a search log database 107, and both may be coupled with the query rewrite generator 110, the additional query rewrite generator(s) 111 and/or the query rewrite analyzer 112. An ad server 108 may be coupled with the search engine 106, the query rewrite analyzer 112, and/or the query rewrite generators 110, 111. Herein, the phrase “coupled with” may mean directly connected to or indirectly connected through one or more intermediate components. Such intermediate components may include both hardware and software based components. Variations in the arrangement and type of the components may be made without departing from the spirit or scope of the claims as set forth herein.

The user device 102 may be a computing device for a user to connect to a network 104, such as the Internet. Examples of a user device include but are not limited to a personal computer, personal digital assistant (“PDA”), cellular phone, or other electronic device. The user device 102 may be configured to access other data/information in addition to web pages over the network 104 with a web browser, such as INTERNET EXPLORER (sold by Microsoft Corp., Redmond, Wash.). The user device 102 may enable a user to view pages over the network 104, such as the Internet.

The user device 102 may be configured to allow a user to interact with the search engine 106, ad server 108, query rewrite analyzer 112, or other components of the system 100. The user device 102 may receive and display a site or page provided by the search engine 106, such as a search page or a page with search results. The user device 102 may include a keyboard, keypad or a cursor control device, such as a mouse, or a joystick, touch screen display, remote control or any other device operative to allow a user to interact with the page(s) provided by the search engine 106 and/or the ad server 108.

The search engine 106 is coupled with the user device 102 through the network 104, as well as being coupled with the query rewrite generator 110, query rewrite analyzer 112, the ad server 108 and/or the search log database 107. The search engine 106 may be a web server. The search engine 106 may provide a site or a page over a network, such as the network 104 or the Internet. A site or page may refer to a web page or web pages that may be received or viewed over a network. The site or page is not limited to a web page, and may include any information accessible over a network that may be displayed at the user device 102. A site may refer to a series of pages which are linked by a site map. For example, the web site of www.yahoo.com (operated by Yahoo! Inc., in Sunnyvale, Calif.) may include thousands of pages, which are included at yahoo.com. Hereinafter, a page will be described as a web page, a web site, or any other site/page accessible over a network. A user of the user device 102 may access a page provided by the search engine 106 over the network 104. As described below, the page provided by the search engine 106 may be a search page that receives a search query from the user device 102 and provides search results that are based on the received search query and may include advertisements associated with the search query.

The search engine 106 may include an interface, such as a web page, e.g., the web page which may be accessed on the World Wide Web at yahoo.com, which is used to search for pages which are accessible via the network 104. The user device 102, autonomously or at the direction of the user, may input a search query (also referred to as a user query, original query, search term or a search keyword) for the search engine 106. A single search query may include multiple words or phrases. The search engine 106 may perform a search for the search query and display the results of the search on the user device 102. The results of a search may include a listing of related pages or sites that is provided by the search engine 106 in response to receiving the search query.

The ad server 108 is coupled with the search engine 106 and/or the query rewrite analyzer 112. The ad server 108 may be configured to provide advertisements to the search engine 106. Alternatively, the search engine 106 and the ad server 108 may be a common component and/or the search engine 106 may select and provide advertisements. The ad server 108 may include or be coupled with an advertisement database that includes advertisements that are available to be displayed by the search engine 106 for sponsored searching. In addition, the advertisements may be associated with one or more search keywords or queries. The search keywords may be purchased or bid on by advertisers. Accordingly, when that search keyword or a related query is searched for, the advertisers who placed bids are placed in competition for display of their advertisements. The rank order of the advertisements may be determined by various factors, some of which may include the quality of the ad as well as the amount the advertiser bidded. A search query may be received and query rewrites may be identified. The ad server 108 may select and provide advertisements to the search engine 106 based on the received query or the query rewrites.

The search log database 107 includes records or logs of at least a subset of the search queries entered in the search engine 106 over a period of time and may also be referred to as a search query log, search term database, keyword database or query database. The search log database 107 may store the search keywords that are used by the ad server 108 in selecting an advertisement for a particular search query. The queries stored in the search log database 107 may include query rewrites and each query may include stored associations to related query rewrites. The search log database 107 may include associations between queries and advertisements provided by the ad server 108. In addition, the search log database 107 may include or be coupled with an advertisement database that includes advertisements provided to the search engine 106. The search log database 107 may include search queries from any number of users over any period of time.

The search log database 107 may also be coupled with a unit dictionary (not shown). The unit dictionary may be a database of user queries or search keywords that are coupled with one another as units. Units may also be referred to as concepts or topics and are sequences of one or more words that appear in search queries. For example, the search query “New York City law enforcement” may include two units, e.g. “New York City” may be one unit and “law enforcement” may be another unit. A unit is a phrase of common words that identify a single concept. As another example, the search query “Chicago art museums” may include two units, e.g. “Chicago” and “art museums.” The “Chicago” unit is a single word, and “art museums” is a two-word unit. Units identify common groups of keywords to maximize the efficiency and relevance of search results. The unit dictionary and the categorization of search queries into units may be used to analyze queries received by the search engine 106. A search query may be broken into units that are compared with units from other queries or query rewrites. Categorization of search queries into units is discussed in commonly owned U.S. Pat. No. 7,051,023 issued May 23, 2006, entitled “SYSTEMS AND METHODS FOR GENERATING CONCEPT UNITS FROM SEARCH QUERIES,” which is hereby incorporated by reference.

The query rewrite generator 110 may provide query rewrites to the search engine 106. The query rewrites may also be provided to the search log database 107. A query rewrite may be a substitute query for a given query. For example, when a user submits a query to the search engine 106, that query may be substituted for a more common word. For example, it is not uncommon for users to misspell a word, so the query rewrite generator 110 may provide substitute queries for the misspelled query.

The query rewrite generator 110 may output a list of candidate rewrites for a given query along with a score indicating the relevance of the rewrite with respect to the query. The candidate set of rewrites may be associated with a candidate set of advertisements. The relevance of the rewrites may be based on the relevance of the ads associated with the rewrites. The candidate set of ads may be analyzed and optimized for selecting a subset of ads with the highest benefit.

The additional query rewrite generator(s) 111 may be one or more additional query rewrite generators that provide query rewrites. The additional query rewrite generator(s) 111 may be from other sources, such as additional search engines or other search log databases. The query rewrites from the query rewrite generator 110 and additional query rewrite generator(s) 111 may be combined into a set of query rewrites to be analyzed and/or optimized as described below. The set of query rewrites may be referred to as a candidate set of query rewrites. Although not shown, the additional query rewrite generator(s) 111 may be in communication with any of the components in communication with the query rewrite generator 110. In one system, the additional query rewrite generator(s) 111 may provide query rewrites to the query rewrite generator 110 which provides those query rewrites to the search engine 102 and/or the query rewrite analyzer 112.

Query rewriting may be used as a mechanism to improve the relevance and click yield of keyword advertising. Query rewriting may provide an output a list of queries q₁, q₂, . . . , qₙ (referred to as rewrites) based on a given a search query q. The ads associated with the rewrites may be relevant to q. Query rewriting may be used to enhance the providing of ads by the ad server 108 in two ways: 1) at index generation time by augmenting the set of indexed keywords with the rewrites, expanding the size of the index, and 2) at serving time by looking up rewrites for a given query, fetching the ads for each rewrite and augmenting an ad candidate set for the original query. The index generation may include a map or association between queries (including rewrites) and ads. The index or map may be used to determine which ads to display for a given query. A candidate set of ads may be determined for a received query. Any ads associated with potential rewrites of that query may also be included in the ad candidate set.

Query rewriting may be related to keyword advertising. It may be difficult to determine the relevance of every ad with respect to every query received. A keyword-ad index mapping may be used to associate keywords with their most relevant ads. However, that mapping may be limited in the number of keywords that it maps for storage and processing reasons. Additional queries that are not mapped may be rewritten to a query that is in the mapping. Accordingly, query rewrites may be used to identify keywords on the map and likewise to identify ads associated with those keywords. Because advertisers may manually or automatically modify when and how their ads are displayed, the ad selection process may be dynamic. It may be easier and more cost effective to add or remove a mapping from one keyword rather than hundreds or thousands of keywords that are associated with an ad to be added or removed. Although, the ad may be associated with a small number of keywords, the use of query rewrites may result in hundreds or thousands of different potential queries being rewritten to one of those keywords.

Query rewriting based on keyword clustering, keyword graph mining, etc., may be a techniques for improving ad relevance and coverage. The estimation of relevance of ads to keywords or the relevance of query rewrites may be based on a similarity. As described below, the Pearson Correlation may be a measure of similarity. In another example, the relevance may be a function of historical click-through rate (CTR) data. An ad that is displayed for a particular query that has a high CTR may be more relevant than an ad with a low CTR. In other words, the CTR may be one measurement of the relevance of ads. The use of query rewrites may make the CTR data more relevant because the CTR for an ad displayed for a particular keyword is also relevant for the query rewrites of that keyword. Query rewriting techniques may produce normalized relevance scores between pairs of queries. Multiplying the relevance score of the original query and a rewrite with the estimated CTR of the rewrite and an ad may be an estimation of ad relevance to the original query.

The query rewrite generator 110, the additional query rewrite generator(s) 111, the ad server 108, the search engine 102 and/or the search log database 107 may be coupled with the query rewrite analyzer 112. The query rewrite analyzer 112 receives a user query from the user device 102 and analyzes potential query rewrites from multiple query rewrite generators, such as the query rewrite generator 110 and/or the additional query rewrite generator(s) 111. The analysis may include an optimization of the rewrites based on a benefit of the ads that are associated with the query rewrites.

The query rewrite analyzer 112 may be a computing device for analyzing and optimizing query rewrites. The query rewrite analyzer 112 includes a processor 120, memory 118, software 116 and an interface 114. The query rewrite analyzer 112 may be a separate component from the query rewrite generator 110, the additional query rewrite generator(s) 111, the search engine 106 and/or the ad server 108. Alternatively, any of the query rewrite generator 110, the additional query rewrite generator(s) 111, the query rewrite analyzer 112, the search engine 106, and/or the ad server 108 may be combined as a single component or device. The interface 114 may communicate with any of the query rewrite generator 110, the additional query rewrite generator(s) 111, the search engine 106, the search log database 107, and/or the ad server 108. The interface 114 may include a user interface configured to allow a user to interact with any of the components of the query rewrite analyzer 112. For example, a user may be able to add or remove keywords and/or ad associations or update usage statistics that are used by the query rewrite analyzer 112.

The processor 120 in the query rewrite analyzer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for analyzing query rewrites.

The interface 114 may be a user input device or a display. The interface 114 may include a keyboard, keypad or a cursor control device, such as a mouse, or a joystick, touch screen display, remote control or any other device operative to interact with the query rewrite analyzer 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the query rewrite analyzer 112 to view or modify the optimization of query rewrite selection.

Any of the components in system 100 may be coupled with one another through a network. For example, the query rewrite analyzer 112 may be coupled with the query rewrite generator 110, the additional query rewrite generator(s) 111, the search engine 106, search log database 107, or ad server 108 via a network. Any of the components in system 100 may include communication ports configured to connect with a network. The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or a WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. For example, the ad server 108 or the search engine 106 may provide pages to the user device 102 over a network, such as the network 104.

The ad server 108, the search engine 106, the search log database 107, the query rewrite generator 110, the additional query rewrite generator(s) 111, the query rewrite analyzer 112 and/or the user device 102 may represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, as discussed above. For example, the user device 102 may be configured to execute a browser application that employs HTTP to request information, such as a web page, from the search engine 106 or ad server 108. The present disclosure contemplates a computer-readable medium that includes instructions or receives and executes instructions responsive to a propagated signal, so that any device connected to a network can communicate voice, video, audio, images or any other data over a network.

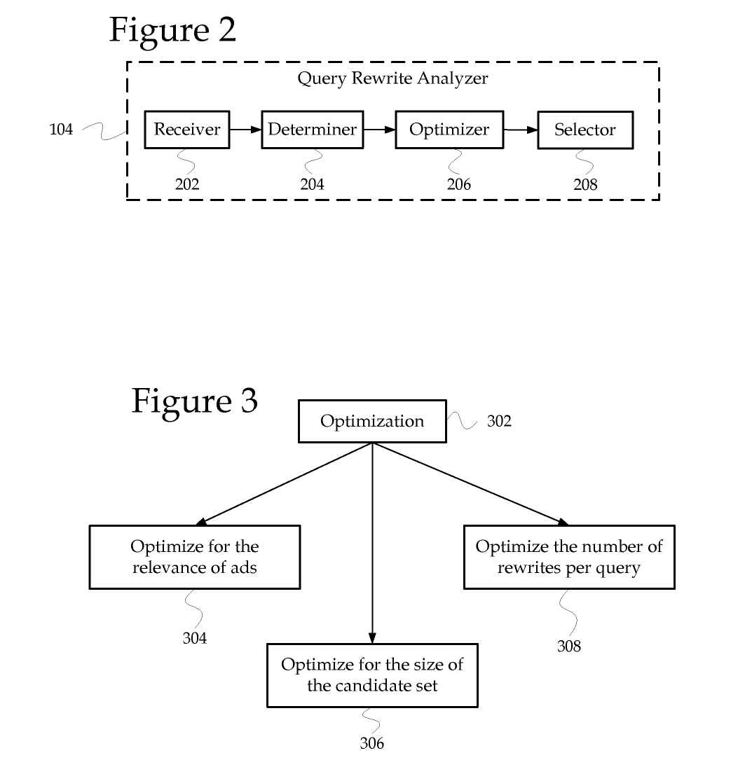

FIG. 2 illustrates the query rewrite analyzer 112. As described with respect to FIG. 1, the query rewrite analyzer 112 may analyze potential query rewrites from the query rewrite generator 110 and/or the additional query rewrite generator(s) 111 that may be substitute queries for a user query provided to the search engine 106 by the user device 102. The query rewrite analyzer 112 may include a receiver 202, a determiner 204, an optimizer 206, and a selector 208. The query rewrite analyzer 112 or any of its components may represent computing devices of various kinds. Any of the components illustrated in FIG. 2 may be implemented in the software 116, stored in the memory 118 and executed by the processor 120 as described in FIG. 1.

The receiver 202 may receive a user query from the search engine 106, which may receive the user query from the user device 102. The receiver 202 may also receive search keywords from the search engine 106 or a candidate set of ads from the ad server 108. The receiver 202 may receive query rewrites for the user query from the query rewrite generator 110 and/or the additional query rewrite generator(s) 111.

The determiner 204 is coupled with the receiver 202. The determiner 204 receives the query rewrites and determines a benefit to use for optimizing selection of a subset of the query rewrites. The determiner 204 may identify a benefit. For example, the benefit may be an ad benefit that determines a value of an ad. The value of the ad may be based on relevance, popularity, profitability, budget, click-through rate (CTR), cost-per-click (CPC), CTR*CPC, and/or similarity to a query rewrite. In addition, the benefit may include a relationship to the organic search results. The determiner 204 identifies a benefit, which may be used in selecting a subset of query rewrites as substitute queries for the original user query. When the determiner 204 identifies an ad benefit, the query rewrite analyzer 104 may select a subset of ads from an ad candidate set that are associated with potential query rewrites.

The optimizer 206 is coupled with the determiner 204. The optimizer 206 receives the query rewrites and the benefit to use for optimization. The optimizer 206 may analyze the query rewrites to determine an optimum subset of query rewrites based on the identified benefit. The benefit may be an ad benefit by which the query rewrites are optimized to maximize the ad benefit. The query rewrites may be associated with various ads through keyword matching or other mechanisms and those ads may be assigned a value based on popularity, profitability, click-through rate (CTR), cost-per-click (CPC), CTR*CPC, and/or similarity to a query rewrite. The optimizer 206 may determine those query rewrites that are associated with the ads that have the highest value. As described below, FIG. 3 illustrates optimization.

The selector 208 may be coupled with the optimizer 206. The selector 208 may choose which query rewrites are used as substitute queries. The selector 208 may choose a subset of query rewrites from the candidate set of query rewrites that are optimized by the optimizer 206. The subset of query rewrites may be used as substitute queries for the original user query. Alternatively, the subset of query rewrites may be used in the selection of advertisements to be displayed in response to receiving a user query. In other words, when a user query is received, it is optimized based on an ad benefit to select a subset of query rewrites and the ads that are associated with that subset of query rewrites may be displayed for the original user query.

FIG. 3 is an illustration of optimization 302. The optimization 302 performed by the optimizer 206 may be based on different benefits. The optimization 302 may select a subset of query rewrites based on maximizing the chosen benefit, such as an ad benefit. The optimization 302 may include optimizing based on the relevance of advertisements 304. The optimization 302 may be based on the size of the candidate set 306. The optimization 302 may be based on the number of rewrites per query 308. The subset of query rewrites may be modified based on relevance of the rewrites.

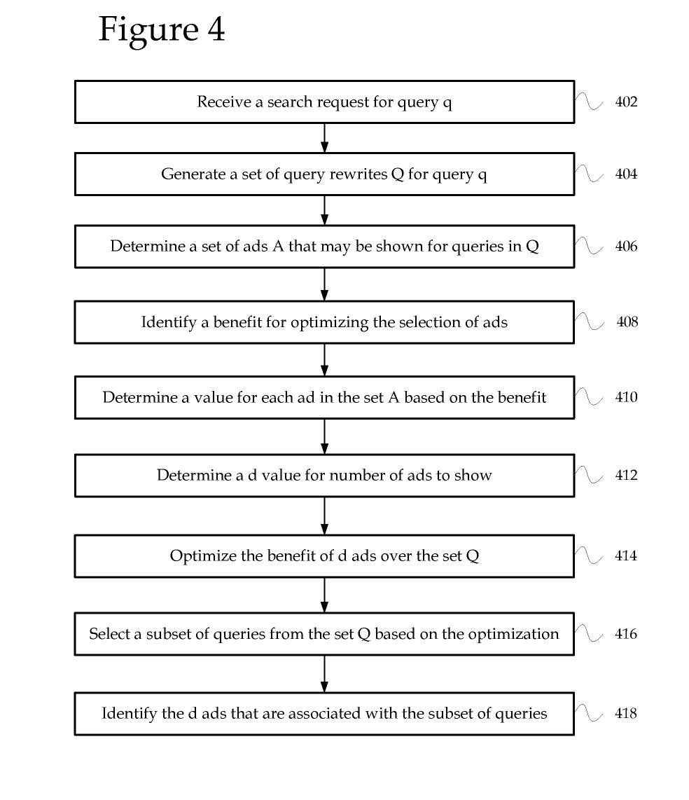

FIG. 4 is a process for optimizing query rewrites for advertising. As discussed above, a user may utilize the search engine 106 by submitting requests for queries, such as query q. In response to the request, the search engine 106 may provide search results relevant to query q, as well as advertisements relevant to query q. In block 402, a search request is received for query q, such as by the search engine 106. In block 404, a set of query rewrites Q is generated based on query q. For example, the query rewrite generator 110 and/or the additional query rewrite generator(s) 111 may generate query rewrites that are similar to the query q and provide those query rewrites to the query rewrite analyzer 112 for analysis.

A set of ads A may be determined that are associated with the queries in the set Q as in block 406. Keyword advertising may include the purchase or bidding of search keywords (queries), such that when that keyword is entered into a query a particular advertisement is displayed with the search results. The purchase or bidding may create an association between that keyword and the advertisement. Multiple advertisers may bid on or purchase a keyword, such that the keyword is associated with multiple ads. Likewise, a particular ad may be associated with multiple keywords. Accordingly, each query in the set Q may be associated with one or more ads and each of those ads comprise the set A as in block 406. Alternatively, certain queries may not be associated with any ads. The set Q may or may not include queries that are not associated with ads. In block 408, a benefit may be identified for optimizing the selection of ads.

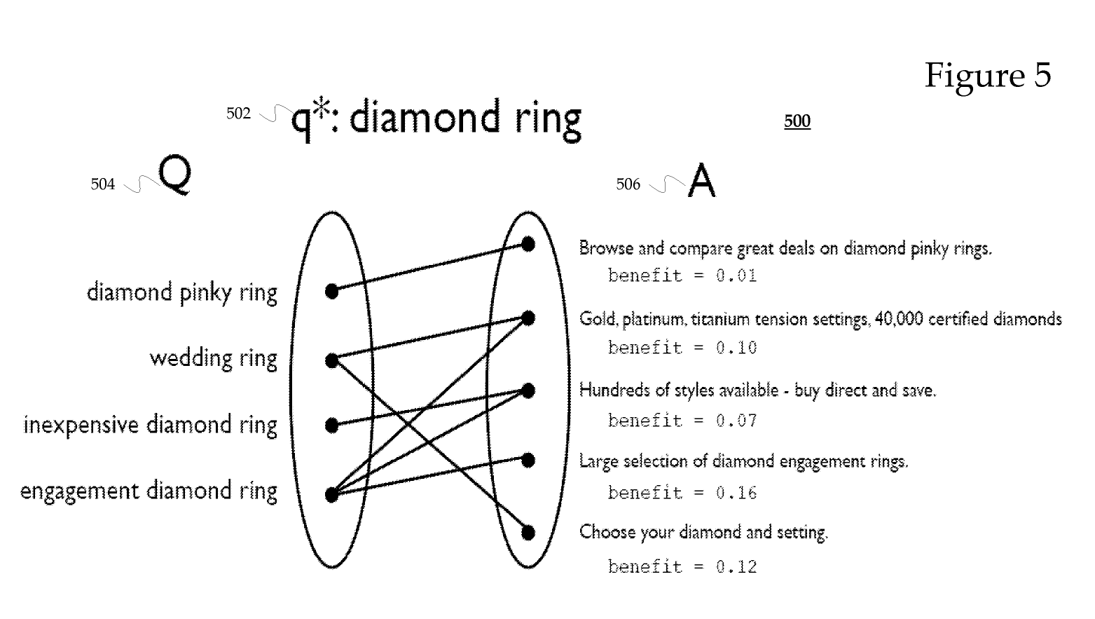

FIG. 5 is a bipartite graph 500 illustrating query rewrites and advertisements, such as in terms of benefits. The graph 500 illustrates query rewrites 504 for a given user query 502. The query rewrites 504 may be associated with ads 506. A user enters the original query 502 and the query rewrite generator 110 and/or the additional query rewrite generator(s) 111 provides the potential query rewrites 504. The query rewrite analyzer 112 may receive ads from the ad server 108 and determine a benefit for the ads 506. The benefit may be a value or score that is indicative of the relevance or potential success of the ad. Each of the ads 506 may be assigned a benefit value based on the click-through rate (CTR), where the higher benefit corresponds to a higher CTR, or more popular ad. The benefit may be the CTR multiplied by 100. Alternatively, the benefit may reflect a profitability of the ad, such as with CTR multiplied by the cost-per-click (CPC), or by ad revenue generated over time.

The query rewrite generator 110 and/or the additional query rewrite generator(s) 111, such as with the optimizer 206, may identify associations between the query rewrites 504 and the ads 506. The associations may resemble the bipartite graph 500. The original query 502 of “diamond ring” may be rewritten as query rewrites 504, including “diamond pinky ring,” “wedding ring,” “inexpensive diamond ring,” and/or “engagement diamond ring.” Each of the query rewrites 504 may be associated with one or more of the ads 506. For example, the query rewrite “wedding ring” is associated with an ad for “Gold, platinum, titanium tension settings, 40,000 certified diamonds” with a benefit of 0.1 and “Choose your diamond and setting” with a benefit of 0.12. The more connections that each ad has would raise its benefit as an indication of similarity with the original query 502. Accordingly, the ads 506 with the most connections or associations with the query rewrites 504 may have their benefit increased based on the number of associations.

Referring back to FIG. 4, the selection of ads to be displayed from the set A may be based on the optimization of a particular benefit of the ads. In block 408, a benefit is identified for optimizing the ad selection. As discussed, ad popularity (e.g. CTR), profitability (e.g. CTR*CPC) or other ad measuring metrics may be identified as a potential benefit. Based on the benefit, each of the ads in the set A may be assigned a value or score that reflects how well the ad achieves the benefit as in block 410. For example, when the benefit is CTR, the value or score may be a percentage value of the CTR. In block 412, a d value is determined that represents the number of ads to show. The d value is the number of ads that are displayed on the search result page for the given query q.

The benefit of d ads is optimized over the set Q in block 414. The optimization may include determining which d ads from the set A provide the highest benefit. The optimization may be used to identify a subset of queries from the set Q as in block 416. The subset of queries may be those queries that are associated with ads with the highest benefit value. The subset of queries may be used to identify d ads that may be displayed with the search results as in block 418. Accordingly, the optimization may include an identification of a subset of queries from the set Q and a selection of d ads that are associated with queries in the subset.

The optimization of selecting a subset of query rewrites or a subset of ads may be based on self imposed constraints. For example, the optimizer 206 may optimize a set of query rewrites to identify four query rewrites 504 as in FIG. 5. Likewise, there may be a constraint on the number of associated ads, such as the five ads 506 in FIG. 5. Accordingly, the optimizer 206 may determine a subset of query rewrites based on the number of associated ads. For example, if the ads are restricted to five, then it may take four query rewrites to determine those five ads. Alternatively, a single query rewrite may be associated with five ads, so it may be the only query rewrite in the subset.

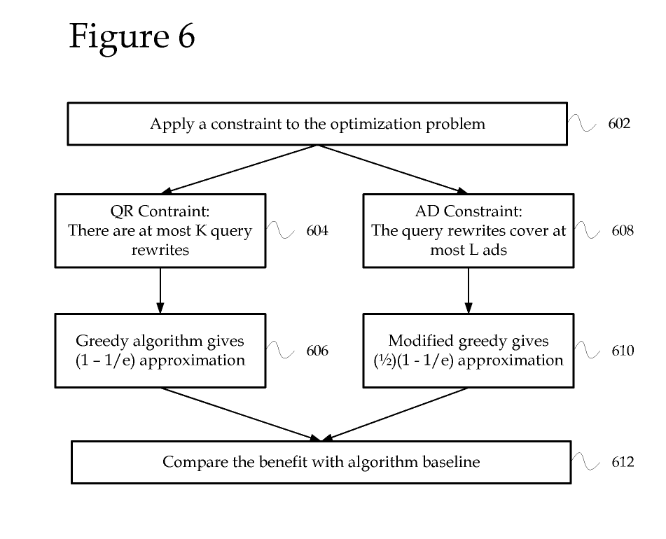

FIG. 6 is a flow diagram of optimization constraints applied for an optimization. The optimization may be based on a chosen benefit, such that a function of the benefit is optimized. As described with respect to FIG. 3, the optimization 302 may include the relevance of ads 304, the size of the ad candidate set 306, and/or the number of query rewrites 308. Those optimization mechanisms may be applied as constraints for optimization as in block 602. The optimization may be used for selecting query rewrites that provide the maximum incremental benefit. The benefit may be represented as a benefit function. The benefit function may be non-decreasing and submodular, which allows for the function to be optimized for that benefit efficiently with a greedy algorithm. For example, the benefit may be based on the associated ads, such as the CTR*PPC. Such an ad benefit may be written as a function that may be optimized to select ads according to the benefit.

A query rewrite constraint may be used to establish a limit of at most K query rewrites as in block 604. Accordingly, the optimization is performed to select a subset of at most K query rewrites for a particular benefit. Utilizing the query rewrite constraint, a greedy algorithm may be used for optimization giving a (1−1/e) approximation in block 606. An ad constraint may be used to establish a limit of at most L ads as in block 608. Accordingly, the optimization is performed to select a subset of at most L ads for a particular benefit. The L ads are those that are associated with a subset of query rewrites. Utilizing the ad constraint, a modified greedy algorithm may be used for optimization giving a (½)(1−1/e) approximation in block 610. The modified greedy algorithm may be similar to the greedy algorithm. In each iteration, the greedy algorithm may select the query that maximizes the incremental benefit. Alternatively, the modified greedy algorithm may select the query that provides the most benefit to size ratio.

Either the query rewrite constraint or the ad constraint may be used as a constraint for the benefit function. The benefit may be compared with the algorithm baseline in block 612. The comparison may be used as a comparison of the accuracy of the optimization. A baseline algorithm may select the most relevant query rewrites with no additional considerations. Compared with the baseline algorithm, the optimizations based on ad benefit may perform best when there are only a few query rewrites (K small) to be selected from a relatively large pool of candidates.

To select the rewrites for a given query, the baseline algorithm may compute a similarity measure between all pairs of queries (q*, q), where each query q or q* is in a set of available queries Q. The query q* may be a potential query rewrite for the original query q. The similarity measure may be a Pearson Correlation, which may be defined on two random variables X, Y with means μx, μy and standard deviations σx, σy as:

$$p ( X , Y ) = \frac{E ( ( X - μ x ) ( Y - μ y )}{{σ}_{X} {σ}_{Y}} .$$

The Pearson Correlation may be used in the benefit calculation of an advertisement for a given query. For example, the benefit β(a) of an advertisement for the given query q* may be the click-through rate (CTR). The CTR of the query ad pair (q, a) may be known and used to determine a benefit β(a) for the ad a in selecting potential query rewrites q*. Although β(a) may be proportional to the CTR for the pair (q*, a), the CTR of the pair (q*, a) may not be a good estimate of the CTR of the pair (q, a). Accordingly, the benefit β(a) may be defined as:

$$β ( a ) = \frac{{\sum }_{q ∈ Γ ( a )} r ( {q}^{*} , q ) \cdot CTR ( q , a )}{{\sum }_{q ∈ Γ ( a )} r ( {q}^{*} , q )} ,$$

where r(q*, q) is the Pearson Correlation. β(a) may be a similarity-weighted average of CTR's. This is merely one implementation of a benefit and the benefit function for optimization.

The system and process described may be encoded in a signal bearing medium, a computer readable medium such as a memory, programmed within a device such as one or more integrated circuits, one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for selecting a subset of query rewrites comprising:
receiving an original query;
generating a plurality of query rewrites, wherein the plurality of query rewrites are similar to the original query;
determining advertisements that are related to the plurality of query rewrites, wherein at least one of the advertisements is associated with at least one of the plurality of query rewrites;
optimizing the advertisements based on an ad benefit of the advertisements; and
selecting a subset of advertisements based on the optimization, wherein the subset of query rewrites are associated with the subset of advertisements, further wherein the subset of query rewrites are a subset of the plurality of query rewrites.

2. The method of claim 1 wherein the association between one of the advertisements and at least one of the plurality of query rewrites comprises a purchase of the one of the advertisements to be displayed for a display of the at least one of the plurality of query rewrites.

3. The method of claim 1 wherein the purchase is a keyword bidding, wherein the at least one of the plurality of query rewrites comprises a keyword.

4. The method of claim 1 wherein the optimizing the advertisements based on an ad benefit comprises:
identifying a number of query rewrites, wherein the number establishes a size of the subset of query rewrites;
analyzing the advertisements to determine which advertisements provide a higher ad benefit; and
selecting a subset of the advertisements with the higher ad benefit, wherein the subset of the advertisements are associated with the subset of query rewrites.

5. The method of claim 4 wherein the ad benefit comprises at least one of a click-through rate (CTR), a cost per click (CPC), CTR*CPC, ad revenue, or ad profitability.

6. The method of claim 1 wherein the ad benefit comprises a benefit function and the optimizing the advertisements based on an ad benefit comprises optimizing the ad benefit function.

7. The method of claim 6 wherein the optimizing comprises a greedy algorithm or a modified greedy algorithm.

8. The method of claim 1 wherein the plurality of query rewrites are generated from multiple query rewrite generators.

9. A method for selecting query rewrites based on a benefit comprising:
receiving a query;
receiving a plurality of query rewrites for the query;
determining a benefit for selecting a subset of query rewrites from the plurality of query rewrites;
determining an optimized benefit for the plurality of query rewrites; and
selecting the subset of query rewrites based on the optimized benefit.

10. The method of claim 9 wherein the benefit comprises an advertisement benefit based on a display of an advertisement.

11. The method of claim 10 wherein a plurality of advertisements are associated with the plurality of query rewrites.

12. The method of claim 11 wherein the optimization comprises identifying advertisements from the plurality of advertisements with a higher advertisement benefit.

13. The method of claim 12 wherein the advertisement benefit comprises a click-through rate (CTR), a cost per click (CPC), CTR*CPC, advertisement revenue, or combinations thereof.

14. The method of claim 12 wherein the subset of query rewrites are selected based on the identified advertisements from the plurality of advertisements with a higher advertisement benefit.

15. A query rewrite identification system comprising:
a search engine that receives a query over a network;
an ad server in communication with the search engine that provides advertisements associated with queries;
a query rewrite generator in communication with the search engine that generates a plurality of query rewrites, wherein the plurality of query rewrites are substitute queries for the received query, further wherein query rewrites from the plurality of query rewrites are associated with at least one advertisement; and
a query rewrite analyzer in communication with the query rewrite generator that selects a number of query rewrites from the plurality of query rewrites, wherein the selection of the number of query rewrites is optimized for selecting query rewrites that are associated with advertisements that have a higher benefit.

16. The system of claim 15 wherein the optimization includes determining and selecting the number of query rewrites based on those associated advertisements with a higher click through rate.

17. The system of claim 15 wherein the benefit comprises a click-through rate (CTR), a cost per click (CPC), CTR*CPC, an ad revenue, or combinations thereof.

18. The system of claim 15 wherein the association between the advertisements and the query rewrites comprises a purchase of one of the advertisements to be displayed for a display including the associated query rewrite.

19. The system of claim 18 wherein the purchase comprises a keyword bidding, wherein the associated query rewrite comprises a keyword that is bidded for.

20. The system of claim 15 further comprising an additional query rewrite generator in communication with the search engine that generates additional query rewrites that are a part of the plurality of query rewrites.

21. In a computer readable storage medium having stored therein data representing instructions executable by a programmed processor for optimizing substitution of a given query, the storage medium comprising instructions operative for:
receiving a plurality of query rewrites, wherein the query rewrites comprise potential substitute queries for the given query;
associating advertisements with the plurality of query rewrites;
identifying a benefit for each of the query rewrites from the plurality of query rewrites, wherein the benefit for each of the plurality of query rewrites comprises a popularity of the associated advertisements;
determining an optimized benefit for each of the plurality of query rewrites based on an identified number of queries to substitute for the given query; and
selecting a subset of query rewrites from the plurality of query rewrites, wherein the subset of query rewrites are optimized to provide a higher benefit and wherein the subset includes the identified number of query rewrites.

22. The storage medium according to claim 21 wherein the determining an optimized benefit comprises:
identifying advertisements with a higher popularity, wherein the identified advertisements are associated with the identified number of queries to substitute.

23. The storage medium according to claim 21 wherein the popularity of the associated advertisements comprises a click-through rate (CTR), a cost per click (CPC), CTR*CPC, or combinations thereof.
